(19) United States
(12) Patent Application Publication
(10) Pub. No.: US 2025/0200873 A1
(43) Pub. Date: Jun. 19, 2025

(54) TWO DIMENSIONAL IMAGE PROCESSING TO GENERATE A THREE DIMENSIONAL MODEL AND DETERMINE A TWO DIMENSIONAL PLAN

(71) Applicant: Amazon Technologies, Inc., Seattle, WA (US)

(72) Inventors: Jhih-Yuan Lin, New Taipei City (TW); Meng-Jiun Chiou, Taipei City (TW); Chih-Ting Liu, Taipei City (TW); Chen Hu, Milpitas, CA (US); Yu Luo, Mountain View, CA (US); Dawei Li, San Jose, CA (US); Shao-Hang Hsieh, Taoyuan City (TW); Yang Liu, Saratoga, CA (US); Kah Kuen Fu, Cupertino, CA (US)

(21) Appl. No.: 18/541,251

(22) Filed: Dec. 15, 2023

(51) Int. Cl. G06T 17/00; G06T 7/12; G06T 7/13; G06T 7/70; G06V 10/24; G06V 10/762; H04N 5/74

(52) U.S. Cl. CPC G06T 17/00; G06T 7/12; G06T 7/13; G06T 7/70; G06V 10/24; G06V 10/762; H04N 5/74

(57) ABSTRACT

Techniques for two-dimensional (2D) image processing to generate a three-dimensional (3D) model and determine a 2D plan are described herein. In an example, a 3D model of a room can be generated by using a video file portion of a video file as a first input to a first machine learning (ML) model. Semantic segmentation of the room can be generated by using the video file portion as a second input to a second ML model. The semantic segmentation may indicate that an object having an object type is shown in a first image frame of the video file portion. A 3D representation of the object in the 3D model can be determined. The 3D model can be corrected by setting a property of the 3D representation to a predefined value. A 2D floor plan of the room can be generated based on the corrected 3D model.

### BACKGROUND

A device can be programed to generate two-dimensional plans of floors of spaces for various reasons. For instance, a two-dimensional floor plan may be generated and presented at a user interface to allow a visualization related to a space. In addition, the user interface can allow edits to the two-dimensional floor plan so that revisions to the space can be made. In any case, it may be desirable to efficiently produce a two-dimensional plan by an application executing on the device.

### BRIEF DESCRIPTION OF THE DRAWINGS

Various embodiments in accordance with the present disclosure will be described with reference to the drawings, in which:

FIG. 1 illustrates two-dimensional plan generation from a three-dimensional model generated with two-dimensional image processing, according to an embodiment of the disclosure;

FIG. 2 illustrates an example flow diagram for two-dimensional plan generation from a three-dimensional model generated with two-dimensional image processing according to an embodiment of the disclosure;

FIG. 3 illustrates example trajectory-based room delineation according to an embodiment of the disclosure;

FIG. 4 illustrates an example block diagram for trajectory-based room delineation according to an embodiment of the disclosure;

FIG. 5 illustrates an example flow of a process for performing trajectory-based room delineation according to an embodiment of the disclosure;

FIG. 6 illustrates an example block diagram for correcting three-dimensional reconstruction modelling according to an embodiment of the disclosure;

FIG. 7 illustrates an example flow of a process for correcting three-dimensional reconstruction modelling according to an embodiment of the disclosure;

FIG. 8 illustrates example two-dimensional projection according to an embodiment of the disclosure;

FIG. 9 illustrates an example flow of a process for two-dimensional projection according to an embodiment of the disclosure;

FIG. 10 illustrates example two-dimensional room shape estimation according to an embodiment of the disclosure;

FIG. 11 illustrates an example flow of a process for two-dimensional room shape estimation according to an embodiment of the disclosure;

FIG. 12 illustrates example inner wall detection according to an embodiment of the disclosure;

FIG. 13 illustrates an example flow of a process for inner wall detection according to an embodiment of the disclosure;

FIG. 14 illustrates two-dimensional plan generation according to an embodiment of the disclosure;

FIG. 15 illustrates an example flow of a process for two-dimensional plan generation according to an embodiment of the disclosure;

FIG. 16 illustrates an example flow of a process for two-dimensional plan generation from a three-dimensional model according to an embodiment of the disclosure; and

FIG. 17 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments described herein are directed to, among other things, techniques for using two-dimensional (2D) image processing to generate a three-dimensional (3D) model for determining a 2D plan. In an example, a computer system generates a 3D model of a room based on an input of a video file to a first machine learning (ML) model. The video file may also be input to a second ML model that can determine a semantic segmentation of the room, which can indicate that the video file depicts an object such as a window or a door. The computer system can correct the 3D model of the room by determining a 3D representation of the object (e.g., a window) in the 3D model and setting a property of the 3D representation to a predefined value (e.g., a window depth). A two-dimensional floor plan can then be generated based on the corrected 3D model. In some examples, the two-dimensional floor plan can be generated based on trajectory-based room delineation, scene understanding to improve 3D reconstruction quality, 3D projection, and inner wall detection.

To illustrate, consider the example of a modeling tool generating a floor plan of a house. The modeling tool can be executed on a smartphone, or its execution can be distributed between the smartphone and a remote computing resource (e.g., a cloud computing service). A camera of the smartphone can be used to generate a video file showing each room in a floor of a house (e.g., a bedroom, a kitchen, a dining room, and a bathroom). The modeling tool can receive the video file and utilize an algorithm pipeline (which may include one or more ML models) to generate a floor plan. For example, the modeling tool can split the video file into separate segments by detecting, from the video file, doors connecting the rooms. Each segment corresponds to a room (e.g., each segment is a portion of the video file, where the portion shows the room). From each segment, a 3D model (e.g., a point cloud or a mesh) can be generated and can be associated with a corresponding room. The collection of 3D models forms an overall 3D model that corresponds to the collection of rooms. Corrections can be applied to objects in the overall 3D model (or in each individual 3D model of a room), such as by filling in 3D gaps corresponding to windows or mirrors in the room. The overall 3D model (or in each individual 3D model of a room) can be collapsed onto a 2D plane to generate a 2D density map of each room. This 2D density map can be further corrected and normalized. For example, 2D data representing inner walls may be detected and removed from the 2D density map to generate a 2D floor plan for a room. Without additional user input (beyond operating the camera to generate the video file and requesting a 2D modeling output), 2D floor plans for individual rooms can be stitched together and normalized to generate an accurate 2D floor plan that represents the space. The 2D floor plan can be presented at a user interface of the smartphone.

Embodiments described herein provide several technological advantages over conventional techniques. For example, conventional techniques for generating floor plans may rely on use of a depth sensor such as a Light Detection and Ranging (LiDAR) sensor and processor that collects a 3D point cloud of each room. This 3D point cloud may be projected vertically onto a 2D plane, and post-processing can be performed to obtain a 2D room shape. This may require manual user input for assembling each room to form a complete 2D floor plan, which may be cumbersome and may result in inaccuracies. Furthermore, many devices may not include a LIDAR sensor and processor, in which case, the 2D modeling may not be even possible. Other conventional techniques that do not involve LiDAR may involve manual user input for detecting floor corners of individual rooms. Image processing can be performed to connect the detected floor corners to form each 2D room shape, and the user input may be required to manually link each room to form the complete 2D floor plan. These approaches may also be cumbersome and may result in inaccuracies. Moreover, these approaches may not provide information on many common room structures such as inner walls. Embodiments described herein can provide an alternative that reduces the user input to generate a complete 2D floor plan at a high accuracy. The embodiments described herein involve an algorithm pipeline that leverages 3D reconstruction technology and automatically generates 2D floor plans from a single scan using non-LiDAR technology (e.g., smartphones). User input can simply relate to scanning a space and requesting a 2D floor plan, without additional user input for assembling each room to generate the entire 2D floor plan.

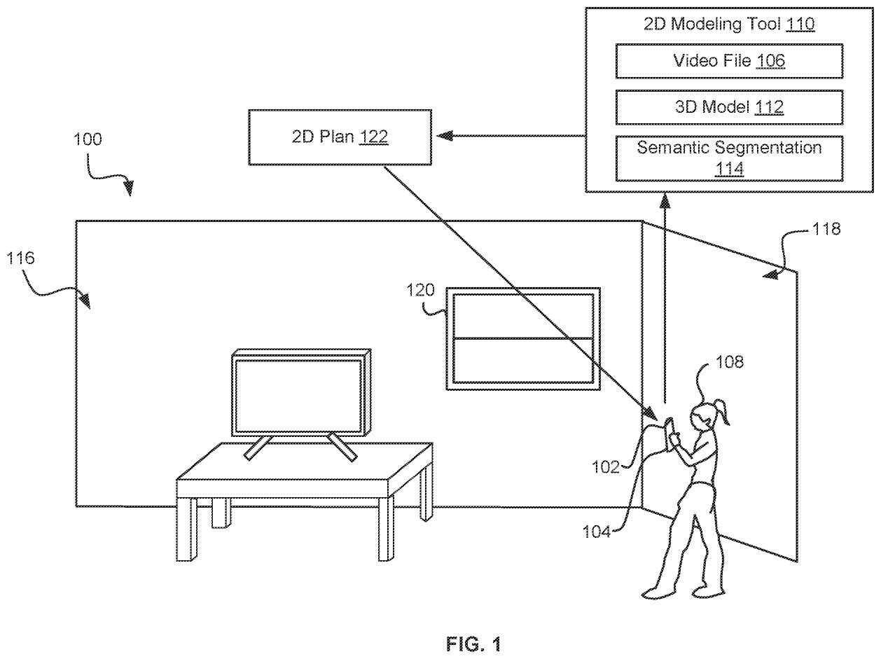

FIG. 1 illustrates two-dimensional (2D) plan generation from a three-dimensional (3D) model 112 generated with 2D image processing, according to an embodiment of the disclosure. A camera 102 of a device 104 can generate a video file 106 showing a room 100. A user 108 operates the device 104 by interacting with a user interface thereof such that the video file 106 is generated upon user input at the user interface and upon a scanning of the room 100 using the camera 102. The room 100 can be in a space. For example, the room 100 may be a living room in a house. The video file 106 may also show other rooms (e.g., a kitchen, bathroom, bedroom, office, etc.) in the same space.

A 2D modeling tool 110 can receive the video file 106 from the device 104 and can generate a 2D plan 122 (e.g., a floor plan) of the room 100 based on the video file 106. In some examples, the 2D modeling tool 110 may be program code executed on the device 104 or on a remote computer system communicatively coupled with the device 104. The 2D plan 122 can be generated based on a 3D model 112 of the room 100. The 2D modeling tool 110 can generate the 3D model 112 of the room 100 from image frames of the video file 106. In some examples, the 2D modeling tool 110 can include one or more machine learning (ML) models, such as deep learning models or any other type(s) of artificial intelligence model(s). The video file 106, or a portion of the video file 106, can be provided as input to a first ML model that can generate the 3D model 112 (e.g., a mesh or a 3D point cloud) for the room 100.

The video file 106 can also be provided as input to a second ML model of the 2D modeling tool 110. The second ML model can generate a semantic segmentation 114 associated with the room. Semantic segmentation 114 may indicate object types for objects (e.g., virtual objects) detected from the video file 106 as being included in the room 100 (e.g., the virtual objects correspond to physical objects in the room). For example, the semantic segmentation 114 may identify a first wall 116, a second wall 118, a window 120, or any other type of object detected to be in the room 100 such as ceilings, mirrors, doors, islands, etc. Some of these objects may cause difficulties in modelling the room 100. For example, for the window 120 in the room 100, depth values in the 3D point cloud of the 3D model 112 may be zero, which can prevent accurate 3D reconstruction of the first wall 116 and may lead to an inability to form a closed polygon representing the room shape. Therefore, the 3D model 112 can be corrected by setting the depth value for 3D object representing the window 120 in the 3D model 112 to a predefined window value. After the 3D model 112 is corrected, the 2D modeling tool 110 can generate the 2D plan 122 by projecting the 3D point cloud of the 3D model 112 onto a 2D x-y plane. Upon generating the 2D plan 122, the 2D modeling tool 110 can cause the 2D plan 122 to be presented on the user interface of the device 104.

In an example, a second portion of the video file 106 can show a second room (e.g., a kitchen). Following the same process using the 2D modeling tool 110, a second 2D plan associated with the second room can be generated. The 2D modeling tool 110 can align the 2D plan 122 and the second 2D plan, such as by aligning a 2D object represented in the 2D plans and corresponding a door or an opening that is common between the room 100 and the second room. Thus, the individual 2D plans for the rooms in the space can be connected to generate a 2D floor plan for the entire house from the video file 106.

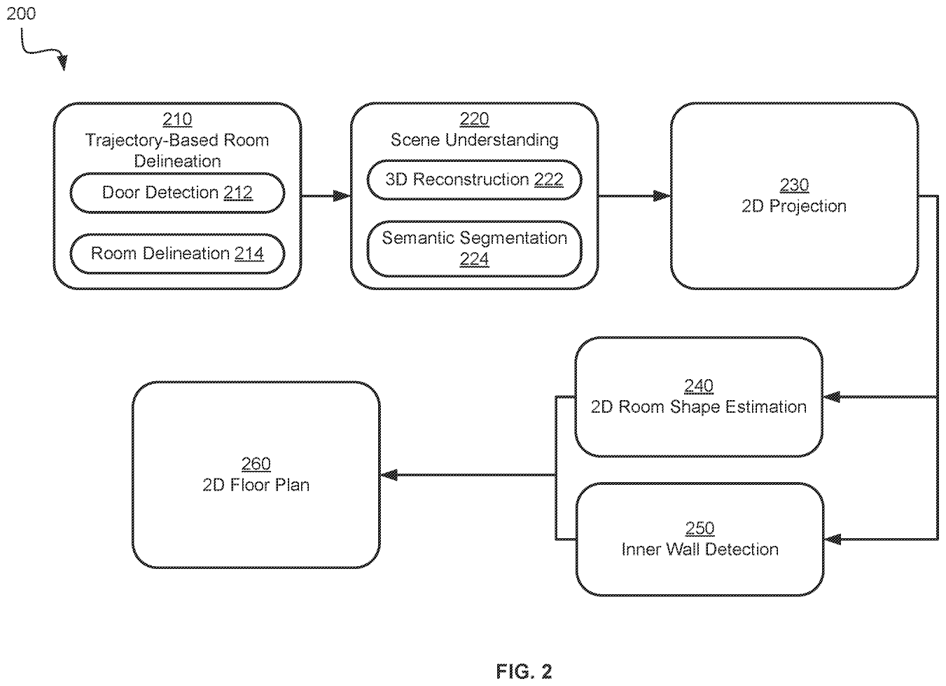

FIG. 2 illustrates an example flow diagram 200 for 2D plan generation from a 3D model generated with 2D image processing according to an embodiment of the disclosure. Steps of the flow diagram 200 may be performed by a 2D modeling tool (e.g., 2D modeling tool 110 in FIG. 1) running on a user device or a computer system.

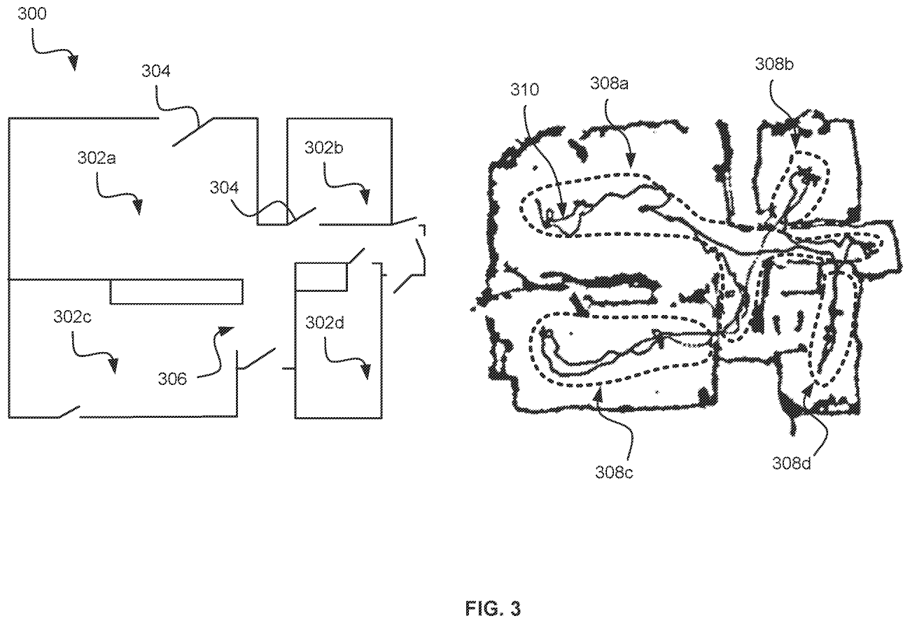

In an example, the flow involves step 210 of trajectory-based room delineation. The 2D modeling tool may include one or more ML models, such as door detection model 212 and room delineation model 214, that receive image frames of a video file showing a room as input. The one or more ML models may be implemented as deep learning models in one example. Output from the one or more ML models can be used to divide the video file into different segments, each of these segments showing a space into different rooms. This is described in further detail in FIGS. 3-5.

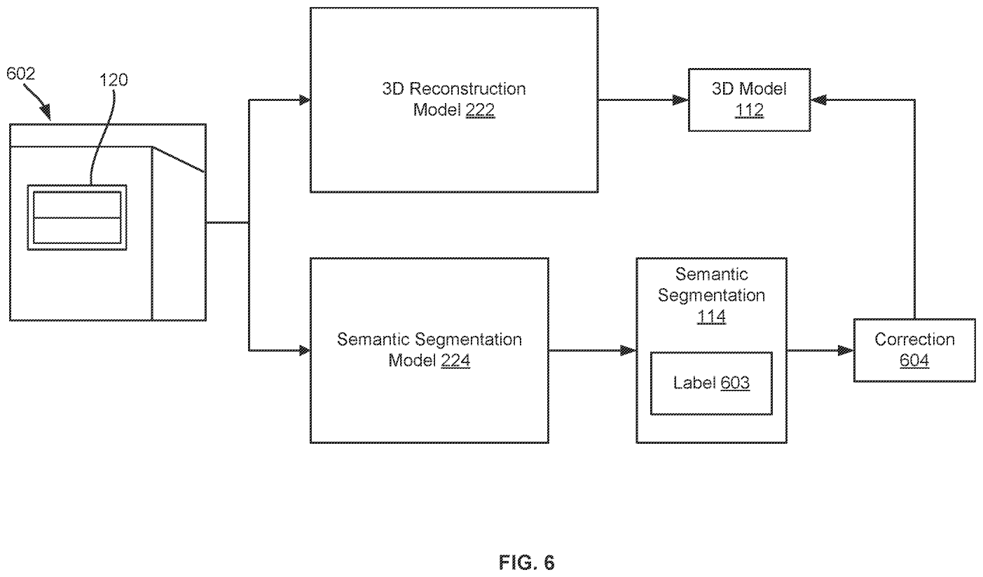

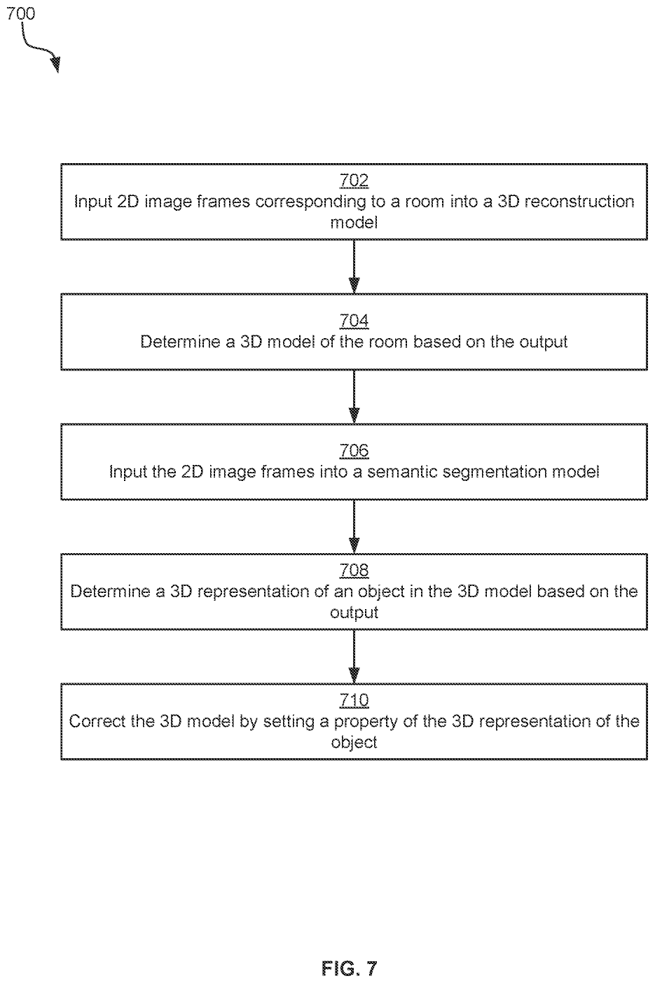

In an example, the flow involves step 220 of scene understanding. The 2D modeling tool may include a 3D reconstruction model 222, which can be an ML model such as NeuralRecon. The 3D reconstruction model 222 can produce a 3D model representation of each room in the space from the corresponding segment of the video file. The 2D modeling tool can also include an ML model (e.g., semantic segmentation model 224) that can segment objects represented in the 3D model of the room into types of objects. The 3D model can be corrected based on the semantic segmentation. This is described in further detail in FIGS. 6-7.

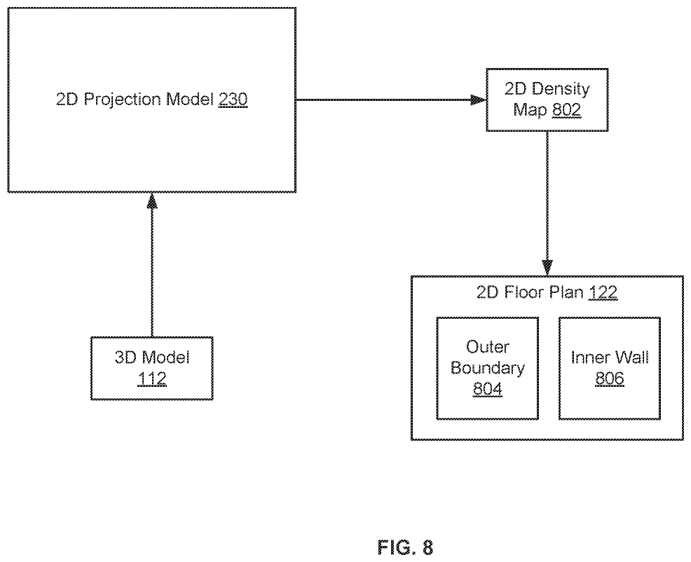

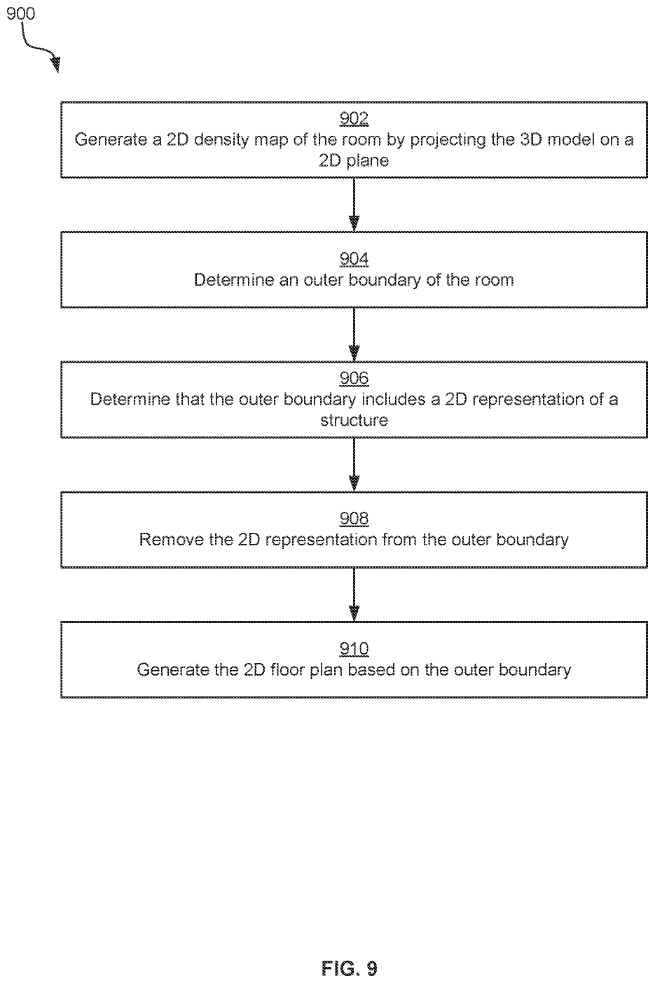

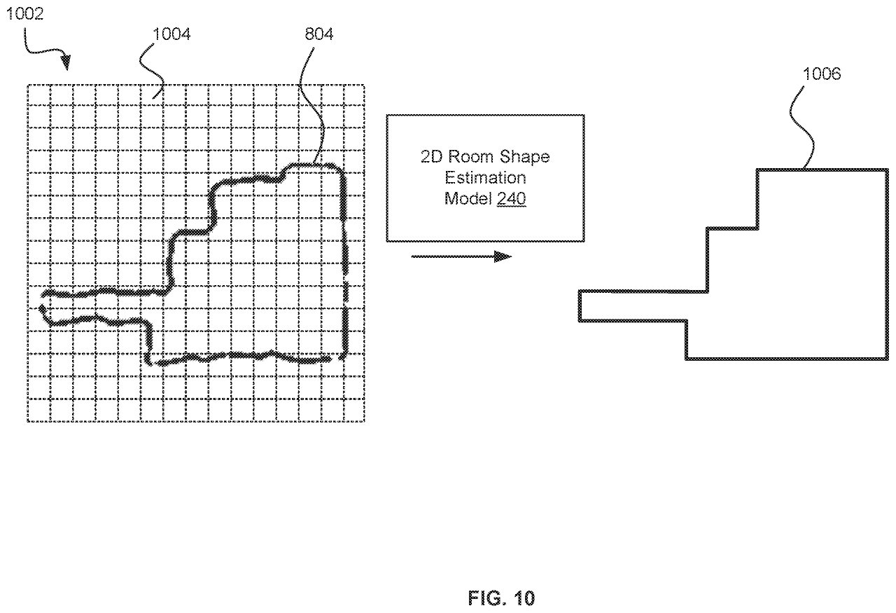

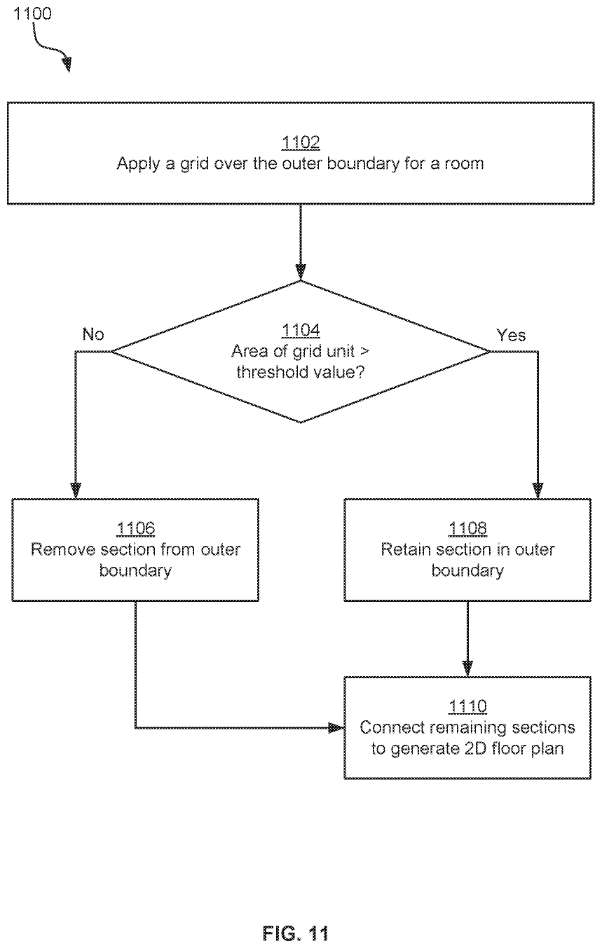

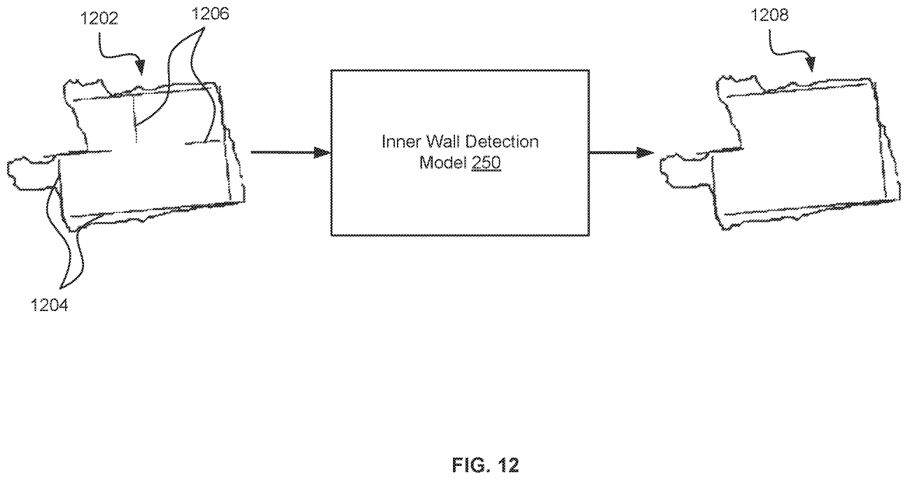

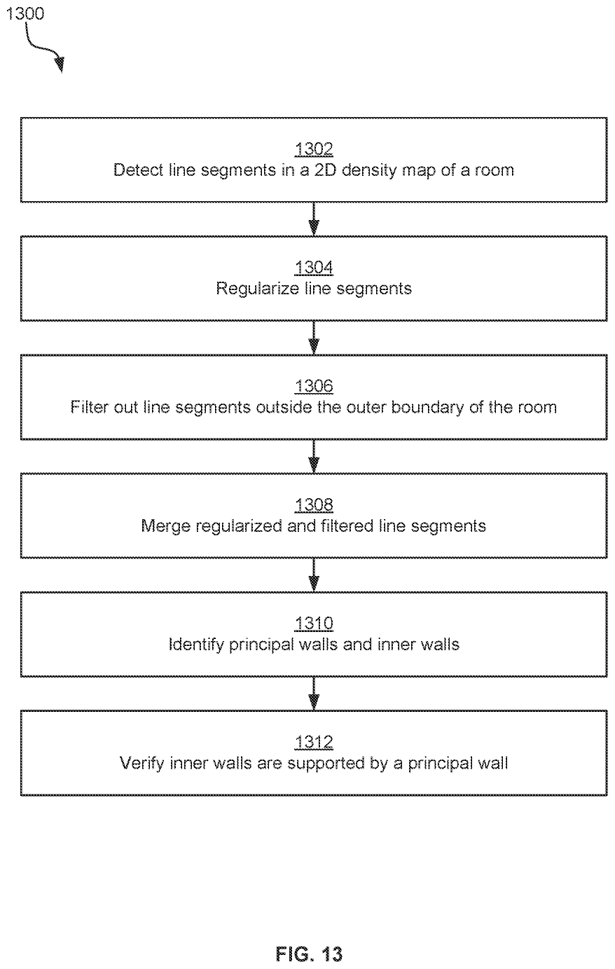

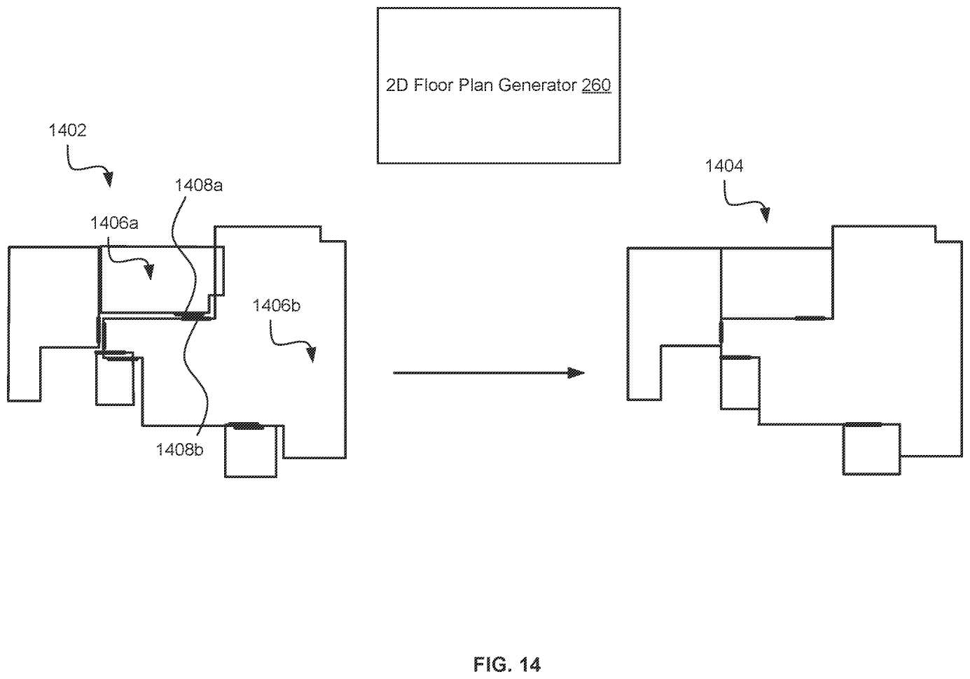

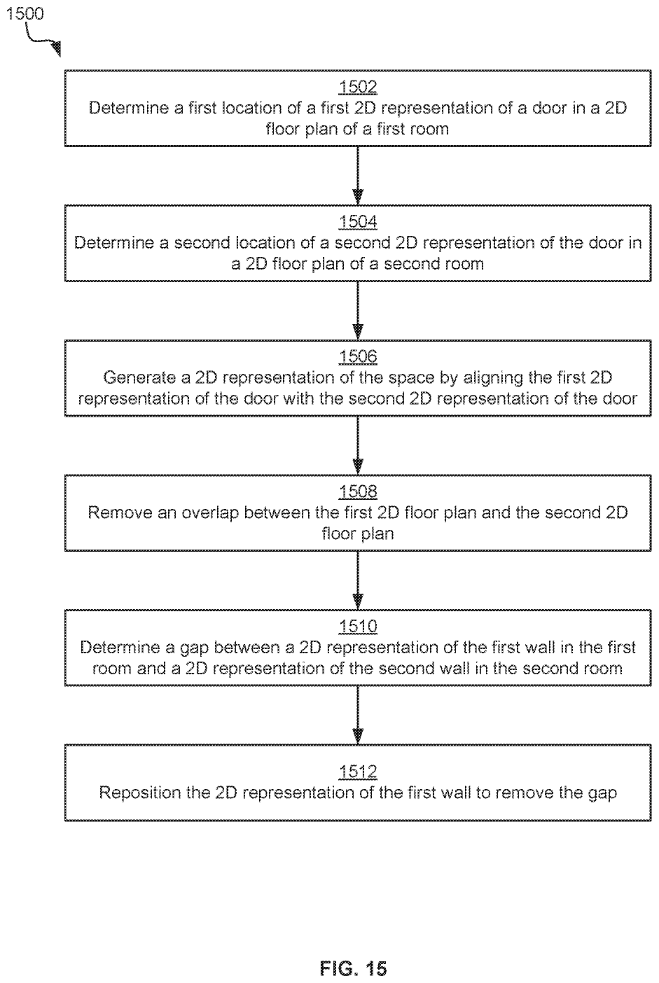

In an example, the flow involves step 230 of 2D projection, in which the 3D model of a room is projected onto a 2D plane to generate a 2D density map. This is described in further detail in FIGS. 8-9. In an example, the flow involves step 240 of 2D room shape estimation from the 2D density map. This is described in further detail in FIGS. 10-11. In an example, the flow involves step 250 of inner wall detection to correct room shape. This is described in further detail in FIGS. 12-13. In an example, the flow involves step 260 of generating a 2D floor plan from the 2D density map. This is described in further detail in FIGS. 14-15.

FIG. 3 illustrates example trajectory-based room delineation according to an embodiment of the disclosure. A space 300 can include multiple rooms 302a-d that are connected by doors 304 or openings 306. To generate a 2D floor plan for the space 300, a user may walk through each of the rooms 302a-d, while operating a camera that generates a video file of the space 300. The user's walk through corresponds to a trajectory 310 in the space 300. Because the structure of the entire space 300 (e.g., a floor of a house) may be complex and composed of multiple rooms, it may be challenging to generate an accurate 2D floor plan for the whole space at once and/or in a timely manner (e.g., with a processing latency that may within a user experience timing requirement). Therefore, it can be beneficial to segment the video file into segments, each showing the different rooms 302a-d and process the segments individually (e.g., sequentially or in parallel) rather than the entire video file. This segmentation can be based on the trajectory 300 (e.g., pose data of the camera over time), in addition to other parameters (e.g., the image frames, etc.). The segmentation can be referred to as a trajectory-based room delineation.

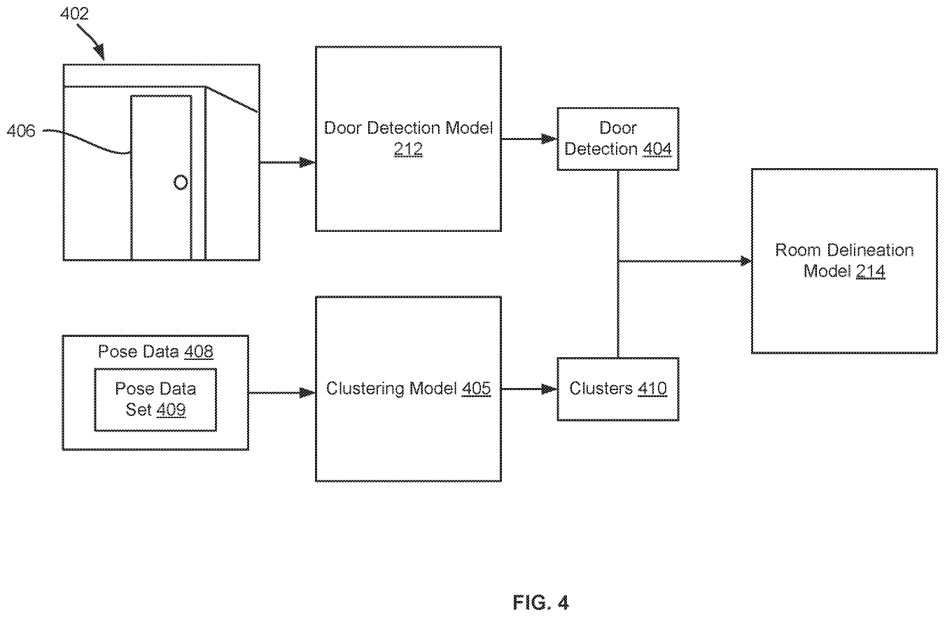

To perform trajectory-based room delineation, the 2D modeling tool can include a door detection model 212, a clustering model 405, and a room delineation model 214. This is depicted in FIG. 4, which illustrates an example block diagram for trajectory-based room delineation according to an embodiment of the disclosure. Image frame 402 from the video file can be provided as input to the door detection model 212, which may include an ML model. The door detection model 212 can generate an output of a door detection 404 for door 406 depicted in image frame 402.

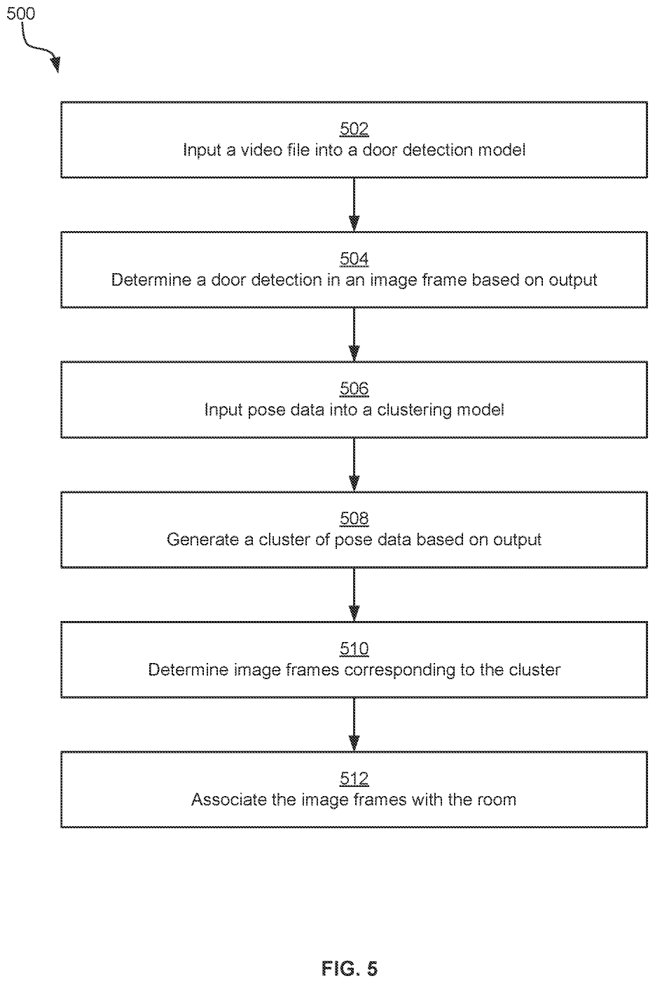

In parallel, pose data 408 can be provided as input to the clustering model 405, which may include an ML model. The pose data 408 can include camera information such as camera poses and camera intrinsic (e.g., optical center, focal length, etc. of the camera) and extrinsic parameters (e.g., parameters based on the location and orientation of the camera). Camera pose can represent the 3D position and orientation of an object and can be used to determine the trajectory 310 of the user while capturing the video file. The pose data 408 can include a pose data set 409 that was detected by the camera at the same time the image frame 402 was captured. The clustering model 405 can generate an output indicating clusters 410 of the pose data 408, including a cluster that includes pose data set 409. The clusters 410 may correspond to the rooms 302a-d. The door detection 404 and clusters 410 can be provided as input to the room delineation model 214. The room delineation model 214 can use the input to generate an output segmenting the video file into different segments 308a-d that each correspond to one of the rooms 302a-d, as further described in FIG. 5.

FIG. 5 illustrates an example flow 500 of a process for performing trajectory-based room delineation according to an embodiment of the disclosure. In some embodiments, the process may be performed by a computer system described herein (e.g., device 104 of FIG. 1). The process (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an example, the flow 500 includes operation 502, where the computer system provides a video file as an input to an ML model (e.g., door detection model 212). The video file may include multiple image frames that are time stamped with their associated time of capture. Some of the image frames may depict a door that separates a first room from a second room in a space. When the video file was generated by a camera, the camera may have captured video of the first room, moved through the door into the second room (while continuing to capture video), and then captured video of the second room. The same door may therefore be seen in image frames that correspond to the first room and the second room. The ML model can generate an output that indicates the image frames in the video file that depict doors. In an example, the flow 500 includes operation 504, where the computer system determines a door detection in an image frame of the video file based on output from the ML model.

In an example, the flow 500 includes operation 506, where the computer system inputs pose data including a pose data set into another ML model (e.g., the clustering model 405). The pose data set may correspond to the same time that the image frame was generated by the camera. In some examples, the door detection generated by the door detection model may also be provided as input to the clustering model. The clustering model can use the input to generate an output that indicates a cluster of pose data sets.

In an example, the flow 500 includes operation 508, where the computer system generates a cluster of pose data sets of the camera, including the pose data set, based on output from the clustering model. For example, based on the pose data set and the door detection, the computer system can generate a distance between the camera and the door. The camera pose (e.g., trajectory) can be tracked until the distance between the camera and the door is zero (e.g., the camera is crossing the threshold of the door when being moved from the first room into the second room). The pose data sets that were captured until the distance is zero can be clustered into a cluster that is associated with the first room. This cluster includes initial pose data and final pose data (the final pose data corresponds to when the distance became zero). The time stamp of the initial pose data is a starting time stamp, whereas the time stamp of the final pose data is an ending time stamp.

In an example, the flow 500 includes operation 510, where the computer system determines the image frames that correspond to the cluster. The computer system can synchronize the image frames and the pose data sets together using time stamps indicating when the image frames and the pose data sets were captured by the camera. For example, a first image frame having the starting time stamp is determined. Similarly, a second image frame having the ending time stamp is determined. These two image frames and the image frames in between are associated with the cluster.

In an example, the flow includes operation 512, where the computer system associates the image frames with the first room associated with the cluster. This can be based on the synchronized pose data and image frames. Thus, the image frames for the first room can be used in subsequent processing steps to generate 2D floor plans for the first room, and image frames for the second room can be used in subsequent processing steps to generate 2D floor plans for the second room.

FIG. 6 illustrates an example block diagram for correcting 3D reconstruction modelling according to an embodiment of the disclosure. A 2D modeling tool (e.g., 2D modeling tool 110 in FIG. 1) can performing scene understanding using a 3D reconstruction model 222 and a semantic segmentation model 224, which may be ML models. In some examples, the 3D reconstruction model 222 can be an ML model such as NeuralRecon.

The 2D modeling tool can use the 3D reconstruction model 222 to generate 3D models 112 of each room in a space. For example, a portion of a video file (e.g., video file 106 in FIG. 1) can be provided as input into the 3D reconstruction model 222. The portion can include image frames designated by the room delineation model 214 as being associated with a particular room (e.g., the portion is a segment of the video file having image frames associated with a same cluster per FIG. 5 above), such as image frame 602. Image frame 602 may depict a window 120. In some examples, the 3D reconstruction model 222 may include a neural radiance field (NeRF) model. The 3D reconstruction model 222 can use the input to generate an output of a 3D model 112 for the room depicted in the portion of the video file. The 3D model 112 may include a 3D point cloud.

In some examples, the 3D reconstruction model 222 can process image frames for each room to generate a truncated signed distance function (TSDF) point cloud. Conventional techniques to generate a reconstructed mesh from a TSDF volume may involve marching cubes. But this process may cause a loss of information and a noisy mesh. Thus, the 3D reconstruction model 222 can instead directly extract a 3D point cloud from the TSDF volume by preserving TSDF values that are less than or equal to zero voxels, and by treating each voxel as a point.

In some examples, the room may include features that may not be accurately reconstructed in a 3D point cloud. Such features can represent doorways, windows, mirrors, openings, etc. For example, the 3D model 112 may have a gap in an area of the 3D point cloud that corresponds to the window 120. To repair the gap, the portion of the video file (including image frame 602) can be provided as input to the semantic segmentation model 224. The semantic segmentation model 224 can generate an output indicating semantic segmentations 114 for various objects depicted in the image frame 602. The semantic segmentation 114 may include a label 603 indicating a particular object type that can be associated with a portion of the 3D model 112 (e.g., a window label for the window 120). The 2D modeling tool can apply a correction 604 to the 3D model 112 based on the label 603, such as to close a gap caused by the window 120. For example, the 2D modeling tool can set a depth value for the 3D representation of the window 120 in the 3D model 112 to a predefined value associated with windows based on the label 603.

FIG. 7 illustrates an example flow 700 of a process for correcting 3D reconstruction modelling according to an embodiment of the disclosure. In some embodiments, the process may be performed by a computer system described herein (e.g., device 104 of FIG. 1). The process (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an example, the flow 700 can include operation 702, where the computer system can input 2D image frames corresponding to a room into a 3D reconstruction model (e.g., 3D reconstruction model 222 of FIG. 6). The 2D image frames may depict the room. In an example, the flow 700 can include operation 704, where the computer system can determine a 3D model (e.g., a mesh or point cloud) of the room based on output from the 3D reconstruction model.

In an example, the flow 700 can include operation 706, where the computer system can input the 2D image frames into a semantic segmentation model (e.g., semantic segmentation model 224 in FIG. 6). In an example, the flow 700 can include operation 708, where the computer system can determine a 3D representation of an object in the 3D model based on output from the semantic segmentation model. The semantic segmentation model may output semantic segmentation of objects in the room. Examples of semantic segmentations may include indication of a floor, ceiling, wall, door, opening, window, mirror, or any other object that can be present in a room. The computer system may determine the portion of the 3D model that is associated with the semantic segmentation of an object. In some examples, 3D representations for certain objects, such as windows or mirrors, may be inaccurately modeled (e.g., have incorrect or missing point cloud values). Failing to account for such object types may lead to an inability to form closed polygons representing room shapes in later 2D floor plan generation steps.

In an example, the flow 700 can include operation 710, where the computer system can correct the 3D model by setting a property of the 3D representation of the object. Different objects can have different object types that are associated with particular properties. Depending on the object type and their associated property, some objects may be excluded or included from the 3D model. For example, the semantic segmentation model may identify a first object representing a window and a second object representing a wall that is adjacent to the window in the room. The portion of the point cloud representing the window may have a gap in the 3D model. The computer system can determine that window object types should be set to have depth values that are the same as surrounding walls. Thus, the computer system can determine a value of a property (e.g., wall depth) of the wall adjacent to the window. The computer system can set the depth value of the window to be the same as the depth value of the wall, which can close the gap of the 3D model.

Other objects may be excluded from the 3D point model. For example, the semantic segmentation model may generate semantic segmentation indicating an object type of a door. The portion of the point cloud in the 3D model representing the door may have a gap. But, it may be beneficial to include a gap indicating a door or an opening in a 2D floor plan. Therefore, the computer system may determine, based on the object type, that the door is to be excluded from correction of the 3D model.

In some examples, the computer system may determine that the 3D model includes missing data (e.g., a gap in the point cloud of the 3D model). For example, the computer system may identify a portion of the 3D model that includes a volume that is greater than a predefined threshold. In some examples, the missing data can be caused by a particular object type (e.g., window or a mirror). The property for the 3D representation of the object having that type in the 3D model (e.g., depth property value) may be set to a predefined value in response to the computer system determining that the missing data corresponds to an image frame that depicts the object.

FIG. 8 illustrates example 2D projection according to an embodiment of the disclosure. The 2D modeling tool (e.g., the 2D modeling tool 110 of FIG. 1) can include a 2D projection model 230, which in some examples may be an ML model. The 3D model 112 (which in some examples may be corrected based on semantic segmentation, as described in FIGS. 6-7) of each room can be provided as input to the 2D projection model 230. The 2D projection model 230 can generate an output indicating a 2D density map 802 for the room based on the inputted 3D model 112. For example, the 2D projection model 230 can project the 3D point cloud of the 3D model 112 onto a 2D plane (e.g., an x-y plane). Density values for the 2D density map 802 may be based on the number of 3D points that are projected onto the same 2D point.

The 2D modeling tool can generate a 2D floor plan 122 of the room based on the 2D density map 802. For example, the 2D modeling tool can determine an outer boundary 804 of the room based on sections of the 2D density map 802 that have the highest density values. In some examples, the room may include features such as inner walls that may not need to be represented in a floor plan. The 2D modeling tool can detect representations of inner walls 806 based on the 2D density map 802. In one example, such representations are removed from the final 2D floor plan 122. In another example, such representations are included in the 2D floor plan 122 such that they can be visualized at a user interface. The shape of the room can be represented in 2D floor plan 122 based on the outer boundary 804 with the representations of the inner walls 806 optionally removed.

FIG. 9 illustrates an example flow 900 of a process for 2D projection according to an embodiment of the disclosure. In some embodiments, the process may be performed by a computer system described herein (e.g., device 104 of FIG. 1). The process (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an example, the flow 900 can include operation 902, where the computer system can generate a 2D density map of the room by projecting the 3D model for the room on a 2D plane. For example, 3D points from the TSDF point cloud for the 3D model can be projected onto an x-y plane. The density of the 2D density map can be the occurrence of points along the z-axis. The computer system can then normalize the 2D density map in gray-scale.

In an example, the flow 900 can include operation 904, where the computer system can determine an outer boundary of the room. For example, the computer system may use binary thresholding (e.g., threshold set equal to zero) on the 2D density map to generate a room mask. The largest closed contour of the room mask can be an initial room shape contour (e.g., the outer boundary of the room). In some examples, the computer system can additionally perform skeletonization on the 2D density map (e.g., reducing binary objects to representations that are one pixel wide). For example, border pixels can be identified and removed on the condition that the removal does not break the connectivity of a corresponding object. This can be useful for feature abstraction and representing an object's topology.

In an example, the flow 900 can include operation 906, where the computer system can determine that the outer boundary includes a 2D representation of a structure, such as an inner wall. It may be beneficial to remove representations of such structures from the 2D density map, as it may not be necessary for the structure to be reflected in a 2D floor plan. Thus, the computer system may determine that a first wall belongs to the outer boundary, and a second wall is contained within the outer boundary (e.g., as an inner wall).

In an example, the flow 900 can include operation 908, where the computer system can remove the 2D representation from the outer boundary. For example, because the second wall is contained within the outer boundary, the 2D representation for the second wall can be removed from the 2D density map. The first wall may be retained in the 2D density map because the first wall is part of the outer boundary. Removing the 2D representation is optional. In one illustrative use case, the 2D representation (e.g., of an inner wall) can be retained and visualized in the final 2D floor plan. In an example, the flow 900 can include operation 910, where the computer system can generate the 2D floor plan based on the outer boundary that has been updated to retain the first wall and remove the second wall.

FIG. 10 illustrates example 2D room shape estimation according to an embodiment of the disclosure. The 2D modeling tool (e.g., the 2D modeling tool 110 in FIG. 1) can include a 2D room shape estimation model 240, which in some examples may be an ML model. The 2D room shape estimation model 240 can determine room shape from the outer boundary 804 of a room (e.g., determined from a 2D density map as described above in FIGS. 8-9). For example, the 2D room shape estimation model 240 can apply a grid 1002 over the outer boundary 804 of the room. The grid 1002 divides the outer boundary 804 of the room into grid units 1004. For each grid unit 1004, the 2D room shape estimation model 240 can determine an area of the grid unit 1004 that is occupied by the representation of the room (e.g., enclosed by the outer boundary 804). The resulting room shape estimation 1006 for the room can be generated by selecting grid units 1004 that have occupied areas that are greater than a threshold value (e.g., 50% occupied). This can provide the benefit of smoothing the outer boundary of the room.

In some examples, the 2D room shape estimation model 240 may apply additional smoothing to the room shape estimation 1006. For example, the 2D room shape estimation model 240 can apply cubic spline interpolation to the room shape estimation 1006 to smooth the jagged pattern produced from the 2D density map.

FIG. 11 illustrates an example flow 1100 of a process for two-dimensional room shape estimation according to an embodiment of the disclosure. In some embodiments, the process may be performed by a computer system described herein (e.g., device 104 of FIG. 1). The process (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an example, the flow 1100 can include operation 1102, where the computer system can apply a grid over the outer boundary for a room. The outer boundary for the room can be generated from a 2D density map, as described above in FIGS. 8-9. But the outer boundary may include inaccuracies such as jagged edges. The grid can be used to identify relevant portions of the outer boundary to produce smoother edges.

In an example, the flow 1100 can include operation 1104, where the computer system can determine if an area occupying the grid unit is greater than a threshold value. If the area is not greater than the threshold value, the flow 1100 can continue to operation 1106. If the area is greater than the threshold value, the flow 1100 can continue to operation 1108. For example, the computer system can determine that a first section of the outer boundary occupies a first grid unit of the grid. The first section can occupy the first grid unit by a first area value that is greater than the threshold value (e.g., 0.5). Thus, for the first grid unit, the flow 1100 can continue to operation 1108. In another example, the computer system can determine that a second section of the outer boundary occupies a second grid unit of the grid. The second section can occupy the second grid unit by a second area value that is smaller than the threshold value. Thus, for the second grid unit, the flow 1100 can continue to operation 1106.

In an example, the flow 1100 can include operation 1106, where the computer system can remove the section from the outer boundary. For example, the first section can be removed from the outer boundary. In some examples, instead of being removed, the first section can be smoothed or aligned with adjacent sections in adjacent grid units that have area values that are above the threshold value.

In an example, the flow 1100 can include operation 1108, where the computer system can retain the section in the outer boundary. For example, the second section can be retained because it occupies a large enough area in the grid unit. This can indicate that the second section is positioned accurately. In an example, the flow 1100 can include operation 1110, where the computer system can connect the remaining sections (e.g., the sections that have not been removed) to generate a 2D floor plan based on the updated outer boundary.

FIG. 12 illustrates example inner wall detection according to an embodiment of the disclosure. Representations of inner walls (e.g., walls that are not constituents of the outer walls represented by a polygon for a room) may or may not be reproduced in 2D floor plans in embodiments described herein. But missing representations of inner walls in the process of generating 2D floor plans may significantly affect a resultant floor plan. To accurately detect representations of inner walls, the 2D modeling tool may include an inner wall detection model 250, which in some examples may include an ML model and/or a model that implements a predefined set of rules (e.g., these rules are coded in the model).

The 2D modeling tool can provide the outer boundary 1202 of a room (e.g., determined from a 2D density map) as input to the inner wall detection model 250. The inner wall detection model 250 can perform line segment detection on the outer boundary 1202. The detected line segments may be noisy (e.g., a single segment may be broken into multiple segments), necessitating further normalization. Therefore, the inner wall detection model 250 can perform regularization (e.g., by parallelizing line segments that are near parallel, orthogonalizing line segments that are near orthogonal, etc.) and filtering (e.g., filtering out unreliable line segments lying outside the outer boundary 1202) of the line segments. The filtered and regularized line segments can be analyzed by the 2D modeling tool to identify principal walls 1204 and inner walls 1206. Principal walls 1204 can include walls that are constituents of the outer walls for the room. Inner walls 1206 can be supported by a principal wall 1204 but may not be constituents of the outer walls. In one example, the inner wall detection model 250 can remove the representations of the inner walls 1206 from the outer boundary 1202 to generate an updated outer boundary 1208 that can be used to generate a 2D floor plan of the room. Nonetheless, removing the representations of the inner walls 1206 may not be performed. Instead, such representations can be retained in the final 2D floor plan and visualized when the final 2D floor plan is presented at a user interface.

FIG. 13 illustrates an example flow 1300 of a process for inner wall detection according to an embodiment of the disclosure. In some embodiments, the process may be performed by a computer system described herein (e.g., device 104 of FIG. 1). The process (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an example, the flow 1300 can include operation 1302, where the computer system can detect line segments in a 2D density map of a room. In some examples, the 2D density map may have had image binarization and skeletonization performed. The computer system can utilize Hough line transforms to detect line segments in the 2D density map. In some examples, the line detection results from Hough line transforms may be noisy and may require further regularization. For example, a single line segment may be broken into multiple disparate line segments.

In an example, the flow 1300 can include operation 1304, where the computer system can regularize the line segments. The computer may regularize the line segments according to a set of rules. For example, line segments that are detected as being near parallel (e.g., within a predefined tolerance) can be made exactly parallel. Similarly, line segments that are detected as being near orthogonal (e.g., within a predefined tolerance) can be made exactly orthogonal, and parallel line segments that are detected as being near collinear (e.g., within a predefined tolerance) can be made exactly collinear.

In an example, the flow 1300 can include operation 1306, where the computer system can filter out line segments that are outside the outer boundary of the room. Depending on the quality of the 2D density map, the regularized line segments may still be noisy. The computer system can therefore filter out line segments lying outside of the outer boundary, except for line segments that are very near (e.g., within a predefined distance) of the outer boundary.

In an example, the flow 1300 can include operation 1308, where the computer system can merge the regularized and filtered line segments. The line segments can be merged according to their collinearity and to distances between line segments. In particular, the line segments can be bucketed by collinearity. Then, line segments can be merged in each of the buckets.

In an example, the flow 1300 can include operation 1310, where the computer system can identify principal walls and inner walls. To identify which line segments are walls, the computer segment can filter out short line segments that are smaller than a predefined threshold (e.g., less than 0.5 meters). Then, the computer system can determine whether the wall is a principal wall or an inner wall based on the alignment of the line segment compared to the outer boundary. For example, the computer system can generate averaged minimum Euclidean distances of sampled points of the line segment to the outer boundary and can filter to determine principal walls. Remaining walls (e.g., that are not identified as principal walls) can be designated as inner wall candidates.

In an example, the flow 1300 can include operation 1312, where the computer system can verify inner walls that are supported by a principal wall. For example, for each inner wall candidate, the computer system can verify by examining whether the inner wall candidate is being “supported” by a principal wall. “Support” can mean that the inner wall candidate satisfies the following conditions: the inner wall candidate is almost (e.g., within an angle tolerance threshold) orthogonal to the principal wall, the inner wall candidate is almost (e.g., within a distance tolerance threshold) connected to the principal wall, and/or the inner wall candidate is almost (e.g., within a distance tolerance threshold) projected on the principal wall. Verified inner wall candidates (e.g., inner walls) can then be removed from the 2D density map used to generate a 2D floor plan for the room.

FIG. 14 illustrates 2D plan generation according to an embodiment of the disclosure. After 2D floor plans have been generated and corrected for each room in a space, the 2D modeling tool (e.g., the 2D modeling tool 110 in FIG. 1) can use a 2D floor plan generator 260 to generate a 2D floor plan for the whole space. In some examples, the 2D floor plan generator 260 may be an ML model.

For example, the 2D floor plan generator can generate an initial stitching 1402 of the 2D floor plans for each room in the space. Each 2D floor plan can be generated using the techniques described herein above. Some of the representations of rooms in the initial stitching 1402 may not be aligned. As described in FIGS. 3-5, door detection may have previously been performed as part of generating 3D models for the space. Thus, the location of doors in each room may be known. And, a single door may be part of two adjacent rooms. For example, first room 1406 may have a first location 1408a of a door, and adjacent second room 1406b may have a second location 1408b of the same door, where these two locations 1408a-b are represented in the 2D floor plan of each one of the two rooms 1406a-b. The 2D floor plan generator 260 can align the first location 1408a and the second location 1408b corresponding to the representations of the door in the two 2D floor plans to properly align the these two 2D floor plans as part of generating the 2D floor plan 1404 corresponding to both rooms. The final 2D floor plan 1404 can be presented (e.g., on a user interface) on a device for the user.

FIG. 15 illustrates an example flow 1500 of a process for 2D plan generation according to an embodiment of the disclosure. In some embodiments, the process may be performed by a computer system described herein (e.g., device 104 of FIG. 1). The process (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an example, the flow 1500 can include operation 1502, where the computer system can determine a first location of a first 2D representation of a door in a 2D floor plan of a first room. The first location of the door can be determined from a door detection process performed on image frames depicting the first room. For example, door data from the 3D model of the first room that is projected onto a 2D plane (e.g., to generate a 2D density map of the first room) can be used to determine the first location.

In an example, the flow 1500 can include operation 1504, where the computer system can determine a second location of a second 2D representation of the door in a 2D floor plan of a second room. The second location of the door can be determined from a door detection process performed on image frames depicting the second room. For example, door data from the 3D model of the second room that is projected onto a 2D plane (e.g., to generate a 2D density map of the second room) can be used to determine the second location. The door can connect the first room and the second room (e.g., the door may be common to the first room and the second room).

In an example, the flow 1500 can include operation 1506, where the computer system can generate a 2D representation of the space by aligning the first 2D representation of the door with the second 2D representation of the door. For example, the first location and the second location can be matched to align a first 2D floor plan for the first room and a second 2D floor plan for the second room. The 2D representations of the first room and the second room can be generated absent additional user input related to aligning 2D floor plans.

In an example, the flow 1500 can include operation 1508, where the computer system can remove an overlap between the first 2D floor plan and the second 2D floor plan. For example, after alignment, portion of the 2D representation of the first room in the first 2D floor plan may overlap a portion of the 2D representation of the second room in the second 2D floor plan. The overlapped portion can be removed from the 2D floor plan for the space.

In some examples, the overlap can be caused by connecting doors. For example, as a camera may capture video of the space in a single scan, doors that connect rooms may be opened. This may cause 3D reconstruction results to contain partial structure of connecting rooms. Therefore, the computer system can identify an overlapping region for each door that connects multiple rooms. The overlapping region can be split into two parts along the door by calculating the cross product of each pixel to one door endpoint and the door vector. The computer system can then identify which region to remove based on segmentation of the trajectory (e.g., the trajectory 310 in FIG. 3).

In an example, the flow 1500 can include operation 1510, where the computer system can determine a gap between a first wall in the first room and a second wall in the second room. In an example, the flow 1500 can include operation 1512, where the computer system can reposition the representation of the first wall in the 2D floor plan to remove the gap. For example, the computer system may move the representation of the first wall that had lower density values than a representation of a second wall in the 2D density map used to generate the 2D floor plan 1404 to close the gap. After overlaps and gaps are corrected, the final 2D floor plan 1404 can be presented (e.g., on a user interface) on a device for the user.

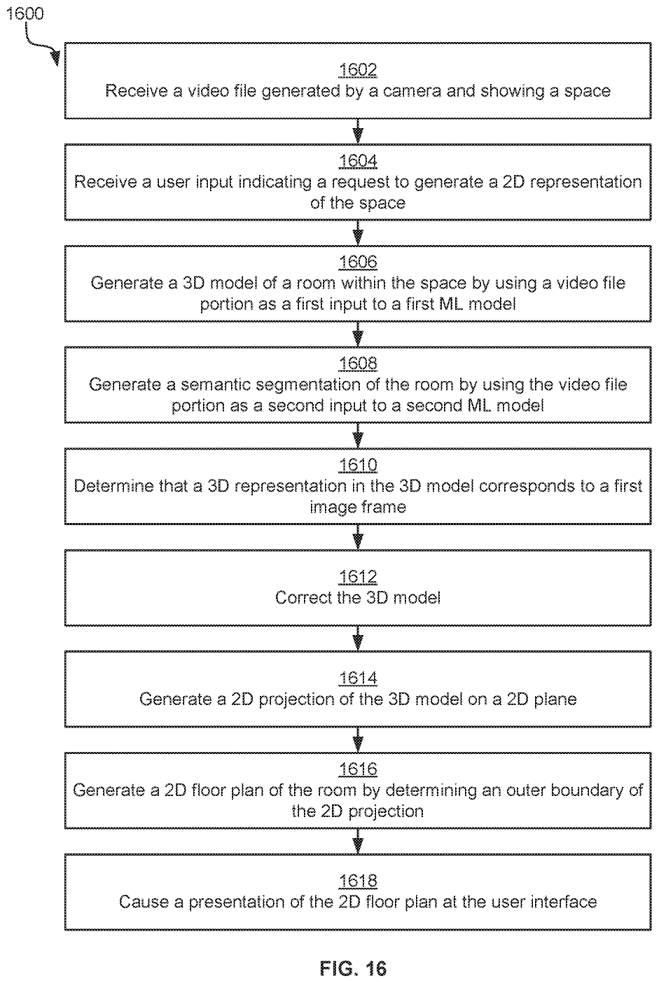

FIG. 16 illustrates an example flow 1600 of a process for 2D plan generation from a three-dimensional model according to an embodiment of the disclosure. In some embodiments, the process may be performed by a computer system described herein (e.g., device 104 of FIG. 1). The process (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an example, the flow 1600 can include operation 1602, where the computer system can receive a video file generated by a camera and showing a space. The space may include a first room and a second room. The video file may be generated in a single walkthrough throughout the space (e.g., the walkthrough corresponding to a user holding the camera and walking through the first room and the second room).

In an example, the flow 1600 can include operation 1604, where the computer system can receive a user input indicating a request to generate a 2D representation of the space. In an example, the flow 1600 can include operation 1606, where the computer system can generate a 3D model of a room within the space by using a video file portion as a first input to a first ML model (e.g., the 3D reconstruction model 222 of FIG. 6). The video file may be included in the request.

In an example, the flow 1600 can include operation 1608, where the computer system can generate a semantic segmentation of the room by using the video file portion as a second input to a second ML model (e.g., the semantic segmentation model 224 of FIG. 6). The semantic segmentation may indicate a first object that has a first object type. In some examples, the computer system can apply a label to a representation of the first object in the 3D model. The label can include the first object type.

In an example, the flow 1600 can include operation 1610, where the computer system can determine that a 3D representation in the 3D model corresponds to a first image frame. The 3D representation may correspond to the first object depicted in the first image frame.

In some examples, the computer system can determine, by using the video file portion as a third input to a third ML model (e.g., door detection model 212 of FIGS. 3 and 4), that a second image frame of the video file shows a door. The computer system can determine a pose data set of the camera corresponding to when the second image frame was generated by the camera. A cluster of pose data sets of the camera can be generated that include the pose data set. The computer system can determine, from the video file, image frames that correspond to the cluster. The image frames can be associated with the room, and the image frames may form the video file portion.

In an example, the flow 1600 can include operation 1612, where the computer system can correct the 3D model. The correction can be performed based at least in part on a label applied to a representation of the object in the 3D model. For example, a value of the first object can be set to a predefined value. Or, based on the object type, an update to a property of the first object can be excluded from correction of the 3D model. In some examples, the computer system can determine that the 3D model includes missing data. The computer system can determine that the predefined value for the first object is to be used based at least in part on the semantic segmentation indicating that the first object has the first object type and is shown in the first image frame.

In an example, the flow 1600 can include operation 1614, where the computer system can generate a 2D projection of the 3D model on a 2D plane.

In an example, the flow 1600 can include operation 1616, where the computer system can generate a 2D floor plan of the room by determining an outer boundary of the 2D projection. In some examples, the computer system can determine that the outer boundary includes a 2D representation of a structure. The 2D representation of the structure can be removed from the outer boundary. In some examples, a first section of the outer boundary may be determined as occupying a first grid unit of a grid by a first area value that exceeds a threshold value. And, a second section of the outer boundary can be determined as occupying a second grid unit of the grid by a second area value that is smaller than the threshold value. The outer boundary can be updated by retaining the first section and removing the second section. The 2D floor plan can be generated based at least in part on the updated outer boundary.

In some examples, the computer system can determine that a first wall belongs to the outer boundary and a second wall is contained within the outer boundary. The 2D floor plan can be generated by at least retaining the first wall and removing the second wall.

In some examples, the 2D floor plan can be a first 2D floor plan for a first room, and the computer system can determine a first location of a door in the first 2D floor plan. The computer system may determine, based at last in part on a third output from the third ML model in response to the third input, that a door is common to the first room and the second room. A second location of the door can be determined in a second 2D floor plan for a second room, and the computer system can align the first 2D floor plan and the second 2D floor plan by at least matching the first location and second location. The aligned 2D floor plans can be used to generate a 2D floor plan for the space. The 2D floor plan for the space can be generated absent additional user input related to aligning the 2D floor plans for the rooms.

In an example, the flow 1600 can include operation 1618, where the computer system can cause a presentation of the 2D floor plan at the user interface. The computer system can send the 2D floor plan to the device, which then presents the 2D floor plan on the user interface.

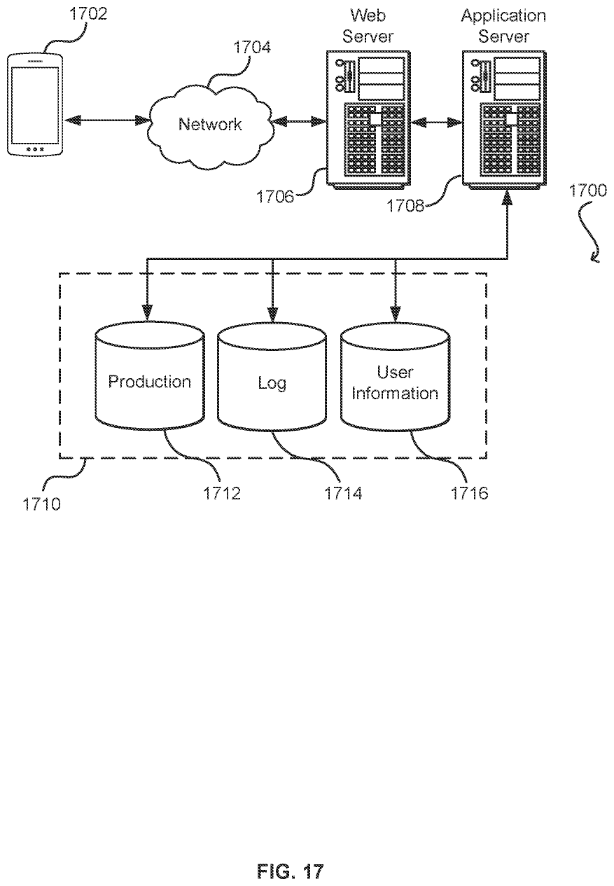

FIG. 17 illustrates aspects of an example environment 1700 for implementing aspects in accordance with various embodiments. As will be appreciated, although a Web-based environment is used for purposes of explanation, different environments may be used, as appropriate, to implement various embodiments. The environment includes an electronic client device 1702, which can include any appropriate device operable to send and receive requests, messages, or information over an appropriate network 1704 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1706 for receiving requests and serving content in response thereto, although for other networks an alternative device serving a similar purpose could be used as would be apparent to one of ordinary skill in the art.

The illustrative environment includes at least one application server 1708 and a data store 1710. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 1702 and the application server 1708, can be handled by the Web server. It should be understood that the Web and application servers are not required and are merely example components, as structured code discussed herein can be executed on any appropriate device or host machine as discussed elsewhere herein.

The data store 1710 can include several separate data tables, databases or other data storage mechanisms and media for storing data relating to a particular aspect. For example, the data store illustrated includes mechanisms for storing production data 1712 and user information 1716, which can be used to serve content for the production side. The data store also is shown to include a mechanism for storing log data 1714, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1710. The data store 1710 is operable, through logic associated therewith, to receive instructions from the application server 1708 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 1702. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 17. Thus, the depiction of the environment 1700 in FIG. 17 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer system comprising:
one or more processors; and
one or more memory storing instructions that, upon execution by the one or more processors, configure the computer system to:
receive a video file generated by a camera, the video file showing a space;
receive a user input via a user interface, the user input indicating a request to generate a two-dimensional representation of the space;
generate, by at least using a video file portion of the video file as a first input to a first machine learning model, a three-dimensional model of a room within the space, the video file portion showing the room;
generate, by at least using the video file portion as a second input to a second machine learning model, a semantic segmentation of the room, the semantic segmentation indicating that a window is shown in a first image frame of the video file portion;
determine that a three-dimensional representation of the window is included in the three-dimensional model;
correct the three-dimensional model by at least setting a depth property of the three-dimensional representation to a predefined value associated with window depths;
generate, after the three-dimensional model is corrected, a two-dimensional projection of the three-dimensional model on a two-dimensional plane;
generate a two-dimensional floor plan of the room by at least determining an outer boundary of the two-dimensional projection; and
cause a presentation of the two-dimensional floor plan at the user interface.

2. The computer system of claim 1, wherein the one or more memory storing instructions that, upon execution by the one or more processors, configure the computer system to:
determine, by using the video file portion as a third input to a third machine learning model, that a second image frame of the video file shows a door;
determine a pose data set of the camera corresponding to when the second image frame was generated by the camera;
generate a cluster of pose data sets of the camera, the cluster including the pose data set;
determine, from the video file, image frames that correspond to the cluster; and
associate the image frames with the room, the image frames forming the video file portion.

3. The computer system of claim 1, wherein the room and the two-dimensional floor plan are a first room and a first two-dimensional floor plan, and wherein the one or more memory storing instructions that, upon execution by the one or more processors, configure the computer system to:
determine a first location of a door in the first two-dimensional floor plan;
determine a second location of the door in a second two-dimensional floor plan generated for a second room; and
align, by at least matching the first location and the second location, the first two-dimensional floor plan and the second two-dimensional floor plan.

4. A computer-implemented method comprising:
generating, by at least using a video file portion of a video file as a first input to a first machine learning model, a three-dimensional model of a room;
generating, by at least using the video file portion as a second input to a second machine learning model, a semantic segmentation of the room, the semantic segmentation indicating that an object having an object type is shown in a first image frame of the video file portion;
determining a three-dimensional representation of the object in the three-dimensional model;
correcting the three-dimensional model by at least setting a property of the three-dimensional representation to a predefined value; and
generating, after the three-dimensional model is corrected, a two-dimensional floor plan of the room based at least in part on the three-dimensional model.

5. The computer-implemented method of claim 4, wherein the video file portion, the room, and the two-dimensional floor plan are a first video file portion, a first room, and a first two-dimensional floor plan, and further comprising:
receiving the video file, the video file showing a space that includes the first room and a second room;
receiving a user input via a user interface, the user input indicating a request to generate a two-dimensional representation of the space;
generating, by at least using a second video file portion of the video file showing a second room, a second two-dimensional floor plan of the second room;
generating, absent additional user input related to aligning two-dimensional floor plans, the two-dimensional representation of the space based at least in part on an alignment of the first two-dimensional floor plan and the second two-dimensional floor plan; and
causing a presentation of the two-dimensional representation at the user interface.

6. The computer-implemented method of claim 4, wherein the video file portion, the room, and the two-dimensional floor plan are a first video file portion, a first room, and a first two-dimensional floor plan, and further comprising:
determining, by at least using the video file as a third input to a third machine learning model and based at least in part on pose data of a camera that generated the video file, that the first video file portion corresponds to the first room and that a second video file portion corresponds to a second room; and
generating a second two-dimensional floor plan of the second room based at least in part on the second video file portion.

7. The computer-implemented method of claim 6, further comprising:
determining, based at least in part on a third output of the third machine learning model in response to the third input, that a door is common to the first room and the second room,
determining, based at least in part on a projection of the three-dimensional model on a two-dimensional plane, door data associated with the door; and
generating a two-dimensional representation of a space by at least aligning the first two-dimensional floor plan and the second two-dimensional floor plan based at least in part on the door data.

8. The computer-implemented method of claim 4, wherein the object and the object type are a first object and a first object type, and further comprising:
determining that the semantic segmentation indicates a second object having a second object type is show in the first image frame;
determining a value of a property of the second object based at least in part on the three-dimensional model; and
setting, based at least in part on the second object type, the predefined value to be equal to the value.

9. The computer-implemented method of claim 4, wherein the object and the object type are a first object and a first object type, and further comprising:
determining that the semantic segmentation indicates a second object having a second object type is show in one or more image frames of the video file portion; and
determining, based at least in part on the second object type, that an update to a property of the second object is to be excluded from the correcting of the three-dimensional model.

10. The computer-implemented method of claim 4, further comprising:
determining that the three-dimensional model includes missing data;
determining that the missing data corresponds to at least the first image frame; and
determining that the predefined value is to be used for the property of the object based at least in part on the semantic segmentation indicating that the object has the object type and is shown in the first image frame.

11. The computer-implemented method of claim 4, further comprising:
generating a two-dimensional density map of the room by at least projecting the three-dimensional model on a two-dimensional plane; and
determining, based at least in part on the two-dimensional density map, an outer boundary of the room, wherein the two-dimensional floor plan is generated based at least in part on the outer boundary.

12. The computer-implemented method of claim 11, further comprising:
determining that the outer boundary includes a two-dimensional representation of a structure; and
removing the two-dimensional representation from the outer boundary.

13. One or more computer-readable storage media storing instructions, that upon execution on a system, cause the system to perform operations comprising:
generating, by at least using a video file portion of a video file as a first input to a first machine learning model, a three-dimensional model of a room;
generating, by at least using the video file portion as a second input to a second machine learning model, a semantic segmentation of the room, the semantic segmentation indicating that an object having an object type is shown in a first image frame of the video file portion;
determining a three-dimensional representation of the object in the three-dimensional model;
correcting the three-dimensional model by at least setting a property of the three-dimensional representation to a predefined value; and
generating, after the three-dimensional model is corrected, a two-dimensional floor plan of the room based at least in part on the three-dimensional model.

14. The one or more computer-readable storage media of claim 13, wherein the operations further comprise:
determining, by at least using the video file as a third input to a third machine learning model, that a door is shown in the video file portion;
generating a two-dimensional projection of the three-dimensional model on a two-dimensional plane; and
generating an updated two-dimensional projection by at least updating a two-dimensional representation of the door in the two-dimensional projection, wherein the two-dimensional floor plan is generated based at least in part on the updated two-dimensional projection.

15. The one or more computer-readable storage media of claim 13, wherein the operations further comprise:
generating a two-dimensional projection of the three-dimensional model on a two-dimensional plane;
determining a correction to be performed on the two-dimensional projection, the correction associated with the object type indicated by the semantic segmentation;
determining a two-dimensional representation of the object in the two-dimensional projection; and
generating an updated two-dimensional projection by at least updating the two-dimensional representation based at least in part on the correction, wherein the two-dimensional floor plan is generated based at least in part on the updated two-dimensional projection.

16. The one or more computer-readable storage media of claim 13, wherein the operations further comprise:
associating a three-dimensional representation of the object in the three-dimensional model with a label, the label including the object type;
generating a two-dimensional projection of the three-dimensional model on a two-dimensional plane, the two-dimensional projection including a two-dimensional representation of the object;
associating the two-dimensional representation of with the label;
determining a correction to be performed on the two-dimensional projection based at least in part on the label; and
generating an updated two-dimensional projection by at least updating the two-dimensional representation based at least in part on the correction, wherein the two-dimensional floor plan is generated based at least in part on the updated two-dimensional projection.

17. The one or more computer-readable storage media of claim 13, wherein the operations further comprise:
generating an outer boundary of the room based at least in part on a projection of the three-dimensional model on a two-dimensional floor plan;
determining that a first section of the outer boundary occupies a first grid unit of a grid by a first area value that exceeds a threshold value;
determining that a second section of the outer boundary occupies a second grid unit of the grid by a second area value that is smaller than the threshold value; and
generating an updated outer boundary by retaining the first section and removing the second section, wherein the two-dimensional floor plan is generated based at least in part on the updated outer boundary.

18. The one or more computer-readable storage media of claim 13, wherein the operations further comprise:
generating an outer boundary of the room based at least in part on a projection of the three-dimensional model on a two-dimensional floor plan;
determining that a first wall belongs the outer boundary; and
determining that a second wall is contained within the outer boundary, wherein the two-dimensional floor plan is generated by at least retaining the first wall and removing the second wall.

19. The one or more computer-readable storage media of claim 13, wherein the two-dimensional floor plan and the room are a first two-dimensional floor plan a first room, and wherein the operations further comprise:
determining a first location of a first two-dimensional representation of a door in the first two-dimensional floor plan;
determining a second location of a second two-dimensional representation of the door in a first two-dimensional floor plan of a second room; and
generating a third two-dimensional representation of a space by at least aligning the first two-dimensional representation and the second two-dimensional representation based at least in part on the first location and the second location and by at least removing an overlap between the first two-dimensional representation and the second two-dimensional representation.

20. The one or more computer-readable storage media of claim 13, wherein the two-dimensional floor plan and the room are a first two-dimensional floor plan a first room, and wherein the operations further comprise:
generating a third two-dimensional representation of a space by at least aligning a first two-dimensional representation and a second two-dimensional representation of a second room, determining a gap between a first wall in the first two-dimensional representation and a second wall in the second two-dimensional representation, and re-positioning at least the first wall.
